(19) United States
(12) Patent Application Publication
(10) Pub. No.: US 2022/0063132 A1
(43) Pub. Date: Mar. 3, 2022

(54) Multi-Use Donut for Piping Installation

(71) Applicants: THOMAS FONG, RICHMOND (CA); RONALD P. WONG, RICHMOND (CA); QUANHONG LIU, RICHMOND (CA)

(72) Inventors: THOMAS FONG, RICHMOND (CA); RONALD P. WONG, RICHMOND (CA); QUANHONG LIU, RICHMOND (CA)

(21) Appl. No.: 17/405,558

(22) Filed: Aug. 18, 2021

(30) Foreign Application Priority Data
Aug. 25, 2020 (CA) 3091050

(51) Int. Cl. B28B 21/02; B28B 21/82

(52) U.S. Cl. CPC B28B 21/02; F16L 59/145; B28B 21/82

(57) ABSTRACT

A donut-shaped component is set around an end of a pipe and both are cast into a concrete slab. Removal of the donut after the concrete has cured leaves an annular recess in the concrete slab around the pipe, which remains in the concrete. Donuts used at both ends of the pipe result in two annular recesses in the concrete, one at each end of the pipe. A cover can be used on the top donut. Further piping connections are made in the annular recesses. The use of firestopping may be avoided, and water leakage through the slab may be eliminated.

### FIELD OF THE INVENTION

The technical field is construction. In particular, the invention relates to piping through concrete.

### SUMMARY

In the construction industry, labour costs are continuously increasing. The multi-use donut disclosed herein will significantly reduce material and labour costs, making installations convenient, faster, uniform and seamless. In addition, this multi-use donut and method mitigate water leakage, property damage and should reduce construction and home-owner insurance costs due to water damage. The multi-use donut also includes pre-manufactured plastic components to allow users to apply the disclosed piping installation method conveniently.

A multi-use donut is a donut-shaped component with a flange. The multi-use donuts are assembled to one or both ends of a pipe. The assembly is then cast in concrete. After curing, the multi-use donuts are removed, leaving annular recesses in the concrete around the end or ends of the pipe.

Disclosed herein is a donut-shaped component comprising: a body with a frustoconical shape and a top surface; a flange extending outwards from a base of the body; and an inner wall extending from the top surface to the base of the body and defining a hole dimensioned to engage with a pipe.

Also disclosed is a kit comprising a first donut-shaped component and a second donut-shaped component, each donut-shaped component comprising a body with a frustoconical shape and a top surface; a flange extending outwards from a base of the body; and an inner wall extending from the top surface to the base of the body and defining a hole dimensioned to engage with a pipe; the kit further comprising a cover for the second donut-shaped component.

Disclosed is a method for installing a pipe in a concrete slab comprising: assembling a riser clamp, a pipe, a first donut-shaped component at a bottom end of the pipe, a second donut-shaped component at a top end of the pipe and a cover for the second donut-shaped component to form an assembly, wherein each donut-shaped component comprises a body with a frustoconical shape and a top surface, a flange extending outwards from a base of the body, and an inner wall extending from the top surface to the base of the body and defining a hole dimensioned to engage with a pipe; attaching the assembly to formwork; pouring concrete to form the slab; allowing the concrete to cure; and removing the donut-shaped components and the cover.

Disclosed is a method for installing a drain in a floor or deck comprising: assembling a drain body, a pipe and a donut-shaped component at a bottom of the pipe to form an assembly, wherein the donut-shaped component comprises a body with a frustoconical shape and a top surface, a flange extending outwards from a base of the body, and an inner wall extending from the top surface to the base of the body and defining a hole dimensioned to engage with a pipe; attaching the assembly to formwork; pouring concrete to form the slab; allowing the concrete to cure; and removing the donut-shaped component to leave an annular recess in the slab for connecting a drainpipe.

Also disclosed is a method for installing piping in a concrete slab comprising: assembling a pipe can and a donut-shaped component at a bottom of the pipe can to form an assembly, wherein the donut-shaped component comprises a body with a frustoconical shape and a top surface, a flange extending outwards from a base of the body, and an inner wall extending from the top surface to the base of the body and defining a hole dimensioned to engage with a pipe; attaching the assembly to formwork; pouring concrete to form the slab; allowing the concrete to cure; removing the donut-shaped component and the pipe can; connecting pipe under the slab; and installing firestopping around the pipe.

### BRIEF DESCRIPTION OF THE DRAWINGS

FIG. 1 is a partially exploded perspective view of a multi-use donut assembly.

FIG. 2 is a flowchart for use of multi-use donuts for piping that penetrates concrete slab.

FIG. 3 is a flowchart for use of a multi-use donut for floor drain and deck drain installation.

FIG. 4 is a flowchart for use of a multi-use donut for saving headroom space when connecting piping.

### DETAILED DESCRIPTION

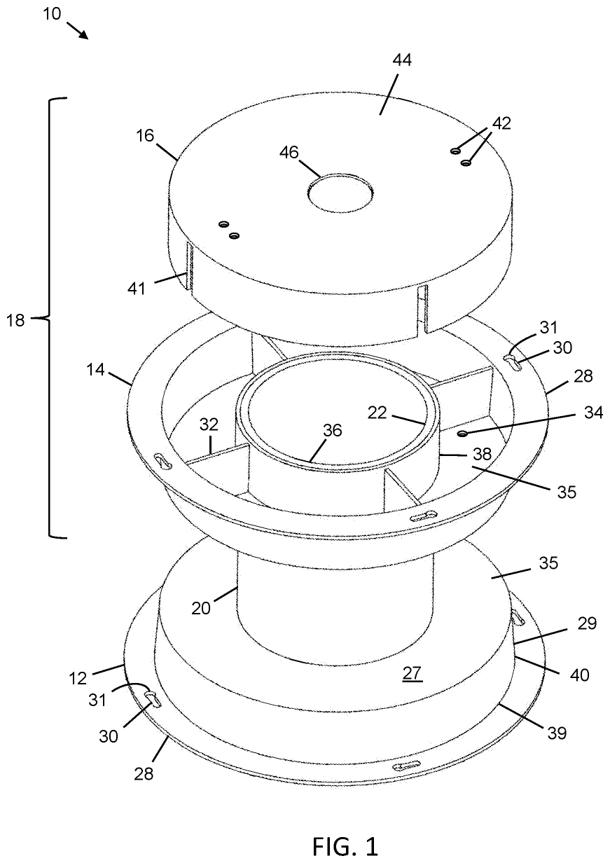

Referring to FIG. 1, a multi-use donut assembly 10 is shown. The multi-use donut assembly 10 includes a pipe 20 and a multi-use donut kit that includes two multi-use donuts 12, 14 (i.e. a lower multi-use donut 12 and an upper multi-use donut 14), and a cover 16. The upper and lower multi-use donuts 12, 14 are the same, except that the upper multi-use donut 14 is inverted compared to the lower multi-use donut 12. The upper multi-use donut subassembly 18 includes the upper multi-use donut 14 and the cover 16. The upper multi-use donut 14 is placed around the top end 22 of a pipe 20 and the lower multi-use donut is placed around the bottom end of the pipe 20.

Evident from FIG. 1, each multi-use donut 12, 14 has a top surface 27, a flange 28 extending outwards from the base of the donut, a tapered side 29, elongated holes 30 with enlarged ends 31, walls 32, an off-centre hole 34 in top 35, and a hole 36 defined by inner wall 38 dimensioned to engage with the outside of the pipe 20. The walls 32 extend from the inner wall 38 to a tapered side wall 40 that defines the tapered side 29. The top 27 and tapered side 29 form a frustoconical body 39. The cover 16 has slots 41, holes 42 in top 44 and recess 46. The off-centre holes 34 are smaller than the holes 36 dimensioned to engage with the pipe 20. The slots 41 align with the walls 32.

The multi-use donuts 12, 14 and the cover 16 are pre-manufactured. The multi-use donuts 12, 14 and the cover 16 are made using a plastic injection moulding process. The plastic multi-use donuts 12, 14 may have a size from 38 mm to 150 mm (1.5″ to 6″). The plastic cover 16 may have a size from 38 mm to 150 mm (1.5″ to 6″).

The multi-use donut provides for a method that simplifies the installation of piping systems in concrete buildings, eliminates or minimizes the need for firestopping applications, saves installation material and labour costs, avoids temporary damming requirements during construction and minimizes water migration to lower floors in the event of water leakage. The multi-use donuts 12, 14 can be used in multiple piping installation scenarios in the building construction industry to save installation time and cost, while achieving a clean and tidy finishing.

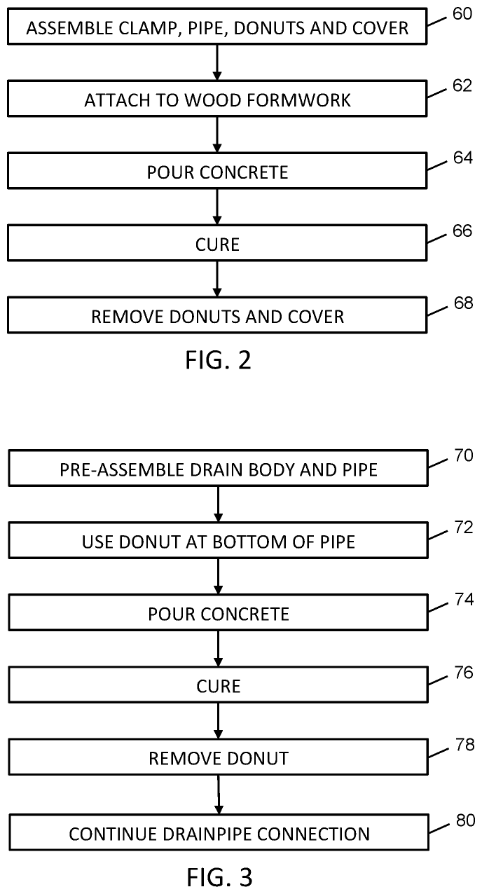

### 1. Use of the Multi-Use Donut for Piping Penetrating Concrete Slab (FIG. 2)

Before pouring the concrete topping, assemble (Step 60) a riser clamp on the metal pipe 20, with a lower multi-use donut 12 at the bottom of the pipe 20, and an upper multi-use donut subassembly 18 at the top 22 of the pipe 20. Note that the upper multi-use donut subassembly 18 is the equivalent of a lower multi-use donut 12 plus a cover 16. The assembly is attached to the wood deck formwork (Step 62). When concrete is poured (Step 64), the whole assembly is cast as part of the concrete slab.

After the concrete is cured (Step 66), remove the top cover, the lower multi-use donut 12 and the upper multi-use donut 14 (Step 68), leaving the metal pipe 20 with the riser clamp in the concrete slab with no space between the pipe 20 and the concrete slab. The recessed space left at the top and underside of the concrete slab around the pipe 20 facilitates mechanical joint pipe coupling for continued riser pipe installation above and below the concrete slab. When using this method of installation for cast-in-place piping penetration, no additional fire stopping is required when a minimum thickness of concrete is maintained to meet the required fire rating as per the building code.

This method eliminates the space between the pipe 20 and the concrete floor slab, saves construction material and labour and the cost of fire stopping, provides uniform piping installation for each penetration, accelerates the installation and shortens the construction time. Further, it mitigates water migration to lower floors on rainy days during construction, and in the event of water leakage post-construction and during occupancy, reducing damage, and should reduce the costs of construction and home-owner insurance.

### 2. Use of the Multi-Use Donut for Floor Drain and Deck Drain Installation (FIG. 3)

A CI (cast iron) drain body and pipe 20 are preassembled (Step 70). Use a lower multi-use donut 12 at the bottom of the pipe 20 (Step 72) as a “place holder” with the pre-assembled CI drain body and pipe 20 at the drain location. Pour the concrete slab (Step 74). Remove the lower multi-use donut 12 (Step 78) after the concrete slab is cured (Step 76), leaving an annular recess at the underside of the slab for continued drainpipe connection (Step 80) using mechanical coupling.

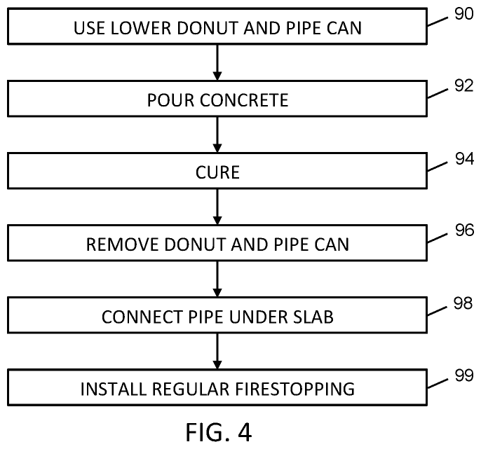

### 3. Use of the Multi-Use Donut for Headroom Space Saving for Piping Connection (FIG. 4)

Use a lower multi-use donut 12 together with a regular pipe can as a “place holder” (Step 90) when pouring the concrete slab (Step 92), and then remove them (Step 96) after the concrete slab is cured (Step 94). Connect the pipe at underside of slab (Step 98) to gain 38 mm (1½″) headroom below the piping installation. Install regular firestopping at piping penetration (Step 99).

### 4. Use of the Multi-Use Donut for Piping Penetrating Poured Concrete Wall

The installation is similar to that for piping penetrating concrete slab, to save firestopping requirements.

1. A donut-shaped component comprising:
a body with a frustoconical shape and a top surface;
a flange extending outwards from a base of the body; and
an inner wall extending from the top surface to the base of the body and defining a hole dimensioned to engage with a pipe.

2. The donut-shaped component of claim 1, comprising further walls extending from the inner wall to a tapered side wall that forms part of the body.

3. The donut-shaped component of claim 1, wherein the flange has elongated holes therein.

4. The donut-shaped component of claim 3, wherein each elongated hole is enlarged at one end thereof.

5. The donut-shaped component of claim 1, wherein the top surface has another hole therein, which is off-centre and smaller than the hole dimensioned to engage with the pipe.

6. The donut-shaped assembly of claim 1, made from plastic.

7. A kit comprising a first donut-shaped component and a second donut-shaped component, each donut-shaped component comprising:
a body with a frustoconical shape and a top surface;
a flange extending outwards from a base of the body; and
an inner wall extending from the top surface to the base of the body and defining a hole dimensioned to engage with a pipe;
the kit further comprising a cover for the second donut-shaped component.

8. The kit of claim 7, wherein each donut-shaped component comprises further walls extending from the inner wall to a tapered side wall that forms part of the body.

9. The kit of claim 7, wherein the cover comprises slots that align with the further walls in the second donut-shaped component.

10. The kit of claim 7, wherein each flange has elongated holes therein.

11. The kit of claim 10, wherein each elongated hole is enlarged at one end thereof.

12. The kit of claim 7, wherein each top surface has another hole therein, which is off-centre and smaller than the hole dimensioned to engage with the pipe.

13. The kit of claim 7, wherein each donut-shaped component and the cover are made from plastic.

14. The kit of claim 7, wherein the cover comprises holes in a top of the cover.

15. The kit of claim 7, wherein the cover comprises a central circular recess in a top of the cover.

16. A method for installing a pipe, drain or piping in a slab, floor or deck comprising:
assembling (a) a pipe or a pipe can and (b) a donut-shaped component at a bottom of the pipe or pipe can to form an assembly, wherein the donut-shaped component comprises:
a body with a frustoconical shape and a top surface;
a flange extending outwards from a base of the body; and
an inner wall extending from the top surface to the base of the body and defining a hole dimensioned to engage with a pipe;
attaching the assembly to formwork;
pouring concrete to form the slab, floor or deck;
allowing the concrete to cure; and
removing the donut-shaped component.

17. The method of claim 16, for installing the pipe in the slab, wherein the pipe is included in the assembly, the method further comprising:
including in the assembly a riser clamp, a second donut-shaped component at a top end of the pipe and a cover for the second donut-shaped component; and
after allowing the concrete to cure, removing the second donut-shaped component and the cover.

18. The method of claim 16, for installing the drain in the floor or deck, wherein the pipe is included in the assembly, the method further comprising including in the assembly a drain body;
wherein the removal of the donut-shaped component leaves an annular recess in an underside of the floor or deck for connecting a drainpipe.

19. The method of claim 16, for installing piping in the slab, wherein the pipe can is included in the assembly, the method further comprising:
after allowing the concrete to cure, removing the pipe can;
connecting the piping under the slab; and
installing firestopping around the piping.
